(19) United States
(12) Patent Application Publication
(10) Pub. No.: US 2008/0103658 A1
(43) Pub. Date: May 1, 2008

(54) Scan tool software update using an image

(75) Inventors: Corneliu Boac, Farmington, MN (US); Manokar Chinnadurai, Owatonna, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/588,314

(22) Filed: Oct. 27, 2006

(51) Int. Cl. G06F 7/00

(52) U.S. Cl. 701/36

(57) ABSTRACT

A method and software for updating a vehicle diagnostic device's software diagnostic device's software stored on a flash memory device when the memory device is located in a memory card reader coupled to a computing device. The method includes communicating with a driver of a flash memory card reader without interacting with the operating system of the computing device. The method also includes reading and writing on the flash memory device without interacting with the operating system of the computing device.

### FIELD OF THE INVENTION

The present invention relates generally to software for a vehicle diagnostic scan tool. More particularly, the present invention relates to a method and apparatus to update software stored on a computer readable medium, such as a compact flash card.

### BACKGROUND OF THE INVENTION

Diagnostic scan tools are designed to diagnose problems in a vehicle. The diagnostic scan tool communicates with the vehicle via software stored in a memory. The memory may be internal or external to the scan tool. Software is also used to diagnose problems with the vehicle. The software used to diagnose the vehicle is often stored on flash memory devices such as a compact (CF) card. The CF card, however, is often not recognizable by computing devices using Windows OS (Microsoft) or Mac OS (Apple) because it is in a proprietary format of the maker of the scan tool. Thus, if the CF card is inserted into a computing device using Windows OS or Mac OS, the computing device will ask if the user wants to format the CF card. As new vehicles are introduced or as new features are developed, the software needs to be updated.

Conventionally, software on the CF card is updated via a long and complicated process. The updates can be downloaded (via internet) or uploaded (via compact disc) to a computing device, such as a personal computer or a server. This is because the CF can not be read or written to by the computing device due to the proprietary format. The scan tool is connected to the personal computer and the software is downloaded into the scan tool. Then the scan tool transfers the updates to the CF card because the scan tool communicate in the same format as the CF card. Thus, the conventional method of updating the CF card can take three or more hours. Thus, the scan tool is out of commission until the updates are completed.

There is a need to be able to directly update the software stored on a CF card via a computing device, such as a personal computer in order to decrease the update time.

### SUMMARY OF THE INVENTION

The foregoing needs are met, to a great extent, by the present invention, wherein in one aspect an apparatus is provided that in some embodiments can be able to directly update the software stored on a CF card via a computing device, such as a personal computer in order to decrease the update time.

In accordance with one embodiment of the present invention, a method of updating a flash memory device used in a vehicle diagnostic device is provided, and can include inserting the flash memory device having a vehicle diagnostic software into a memory card reader of a computing device, the computing device can include an operating system, communicating with a driver of the memory card reader without interacting with the operating system to determine if the flash memory device is coupled to the computing device, determining if the flash memory device has enough available memory for an image of an updated vehicle diagnostic software, and writing the image of the updated vehicle diagnostic software onto the flash memory device without interacting with the operating system of the computing device.

In accordance with another embodiment of the present invention, an article comprising a machine-accessible medium having associated data, wherein the data, when accessed, results in a machine to communicate with a driver of a memory card reader coupled to a computing device without interacting with an operating system of the computing device to determine if a flash memory device is coupled to the memory card reader, determine if the flash memory device has enough available memory for an image of an updated vehicle diagnostic software, and write the image of the updated vehicle diagnostic software on the flash memory device without interacting with the operating system of the computing device.

In accordance with yet another embodiment of the present invention, a method of updating a flash memory device used in a vehicle diagnostic device is provided and can include inserting the flash memory device having a vehicle diagnostic software into a memory card reader of a computing device, the computing device includes an operating system, communicating with a driver of the memory card reader without interacting with the operating system to determine if the flash memory device is coupled to the computing device, determining if the flash memory device has enough available memory for an image of an updated vehicle diagnostic software, determining if the flash memory device is authorized, and writing the image of the updated vehicle diagnostic software onto the flash memory device without interacting with the operating system of the computing device when the flash memory device is authorized and when there is enough available memory.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view of a scan tool that can include software that can be updated with the method according to an embodiment of the invention.

FIG. 2 is a block diagram of the components of the scan tool of FIG. 1.

FIG. 3A is a flowchart illustrating steps for updating software on a flash memory.

FIG. 3B is a continuation of the flow chart illustrating the steps for updating software on the flash memory.

FIG. 3C is a continuation of the flowchart illustrating the steps for updating software on the flash memory.

### DETAILED DESCRIPTION

The invention will now be described with reference to the drawing figures, in which like reference numerals refer to like parts throughout. An embodiment in accordance with the present invention provides a method to update software stored on a computer readable medium such as a compact flash card. The method provides a way to quickly update software stored on a compact flash card (CF) or other flash memory then conventional methods.

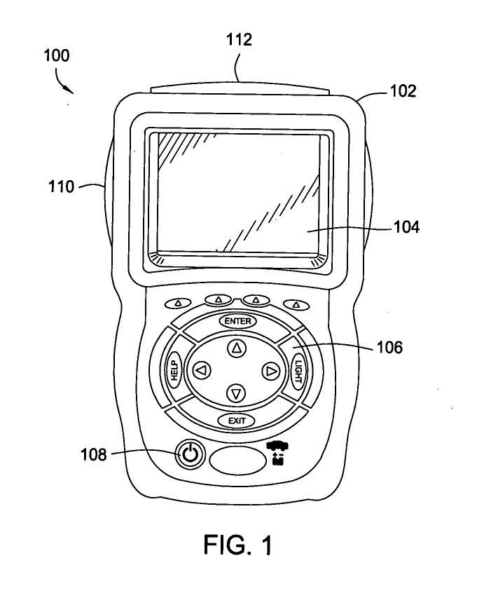

FIG. 1 is a front view of a scan tool 100 that can include software that can be updated with the method according to an embodiment of the invention. The scan tool 100 can be any computing device, such as, for example, the Nemisys scan tool from Service Solutions (a unit of the SPX Corporation) in Owatonna, Minn. The scan tool 100 includes a housing 102 to house the various components of the scan tool, such as a display 104, a user interface 106, a power key 108, a memory card reader 110 and a connector interface 112. The display 104 can be any display, for example, LCD (liquid crystal display), VGA (video graphics array), touch display (can also be a user interface), etc. The user interface 106 allows the user to interact with the scan tool in order to operate the scan tool as desired. The user interface 106 can include function keys, arrow keys or any other type of keys that can manipulate the scan tool 100 in order to operate various menus that are presented on the display. The user interface can also be a mouse or any other suitable input device, including a keypad. The user interface 106 can also include numbers or be alphanumeric. The power key 108 allows the user to turn the scan tool 100 on and off, as required.

Memory card reader 110 can be a single type card reader, such as a compact flash card, floppy disc, memory stick, secure digital, flash memory or other types of memory. The memory card reader 110 can be a reader that reads more than one of the aforementioned memory such as a combination memory card reader. Additionally, the card reader 110 can also read any other computer readable medium, such as CD, DVD, UMD, etc.

The connector interface 112 allows the scan tool 100 to connect to an external device, such as an ECU (electronic control unit) of a vehicle, a computing device, an external communication device (such as a modem), a network, etc. through a wired or wireless connection. Connector interface 112 can also include a USB, FIREWIRE, modem, RS232, RS48J, and other connections to communicate with external devices, such as a hard drive, USB drive, CD player, DVD player, UMD player or other computer readable medium devices.

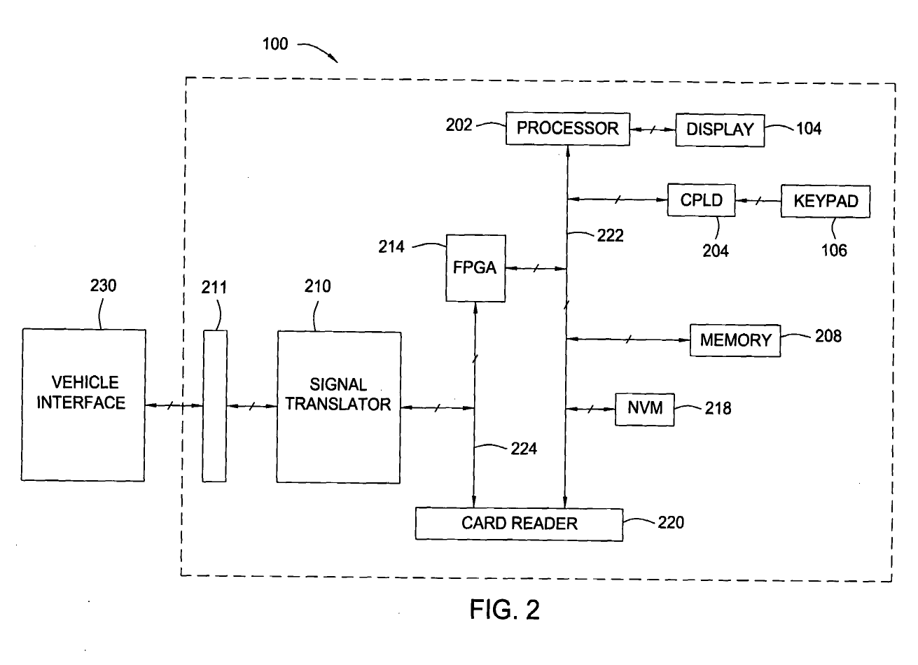

FIG. 2 is a block diagram of the components of the scan tool 100. In FIG. 2, the scan tool 100 according to an embodiment of the invention includes a processor 202, a field programmable gate array (FPGA) 214, a first system bus 224, the display 104, a complex programmable logic device (CPLD) 204, the user interface in the form of a keypad 106, a memory subsystem 208, an internal non-volatile memory 218, a card reader 220, a second system bus 222, a connector interface 211, and a selectable signal translator 210. A vehicle communication interface 230 is in communication with the scan tool 100 through connector interface 211 via an external cable (not shown).

Selectable signal translator 210 communicates with the vehicle communication interface 230 through the connector interface 211. Signal translator 210 conditions signals received from an ECU unit through the vehicle communication interface 230 to a conditioned signal compatible with scan tool 100. Signal translator 210 can communicate with, for example, the following communication protocols: J1850 (VPM and PWM), ISO 9141-2 signal, communication collision detection (CCD) (e.g., Chrysler collision detection), data communication links (DCL), serial communication interface (SCI), S/F codes, a solenoid drive, J1708, RS232, Controller Area Network (CAN), Keyword 2000 (ISO 14230-4) or other communication protocols that are implemented in a vehicle.

The circuitry to translate and send in a particular communication protocol can be selected by FPGA 214 (e.g., by tri-stating unused transceivers) or by providing a keying device that plugs into the connector interface 211 that is provided by scan tool 100 to connect scan tool 100 to vehicle communication interface 230. Signal translator 210 is also coupled to FPGA 214 and the card reader 220 via the first system bus 224. FPGA 214 transmits to and receives signals (i.e., messages) from the ECU unit through signal translator 210.

The FPGA 214 is coupled to the processor 202 through various address, data and control lines by the second system bus 222. FPGA 214 is also coupled to the card reader 220 through the first system bus 224. The processor 202 is also coupled to the display 104 in order to output the desired information to the user. The processor 202 communicates with the CPLD 204 through the second system bus 222. Additionally, the processor 202 is programmed to receive input from the user through the user interface 106 via the CPLD 204. The CPLD 204 provides logic for decoding various inputs from the user of scan tool 100 and also provides glue-logic for various other interfacing tasks.

Memory subsystem 208 and internal non-volatile memory 218 are coupled to the second system bus 222, which allows for communication with the processor 202 and FPGA 214. Memory subsystem 208 can include an application dependent amount of dynamic random access memory (DRAM), a hard drive, and/or read only memory (ROM). Software that operate the basic functions of the scan tool 100 can be stored in the memory subsystem 208, while the software to run the diagnostic functions of the scan tool can be stored on a external memory device such as a CF card or a USB flash drive.

Internal non-volatile memory 218 can be an electrically erasable programmable read-only memory (EEPROM), flash ROM, or other similar memory. Internal non-volatile memory 218 can provide, for example, storage for boot code, self-diagnostics, various drivers and space for FPGA images, if desired. If less than all of the modules are implemented in FPGA 214, memory 218 can contain downloadable images so that FPGA 214 can be reconfigured for a different group of communication protocols.

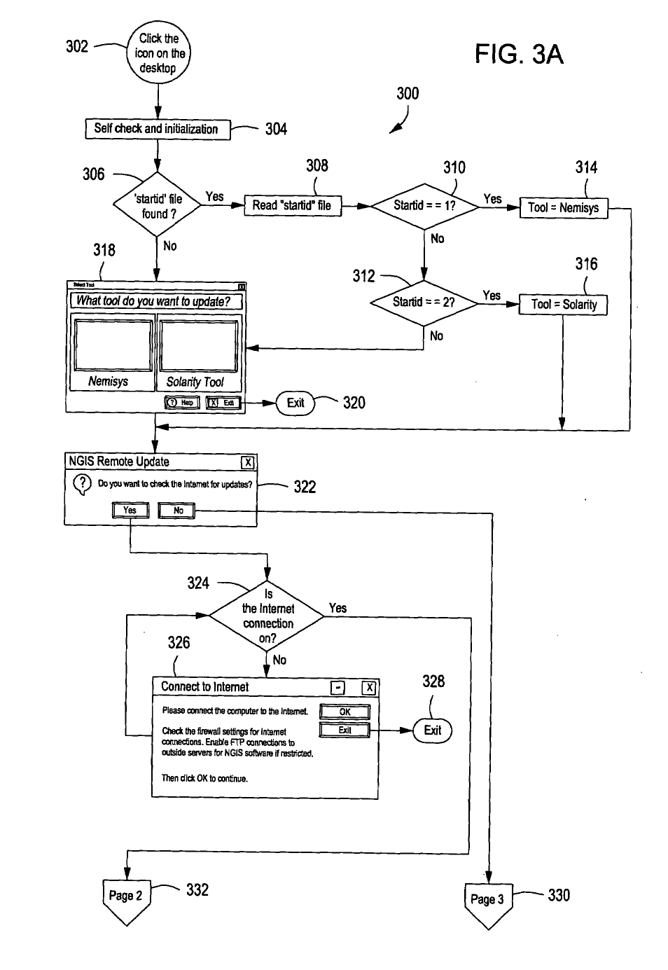

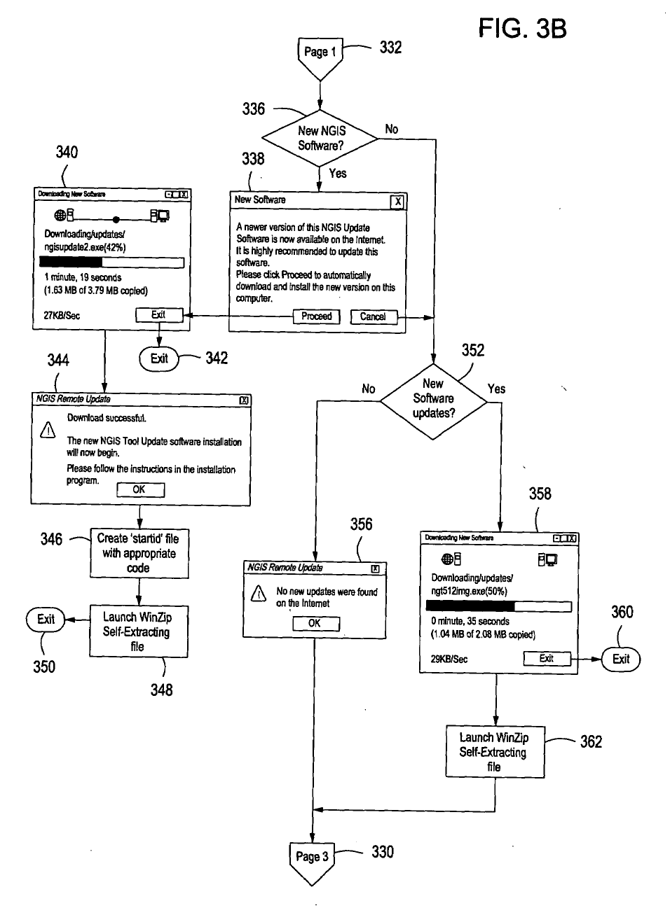

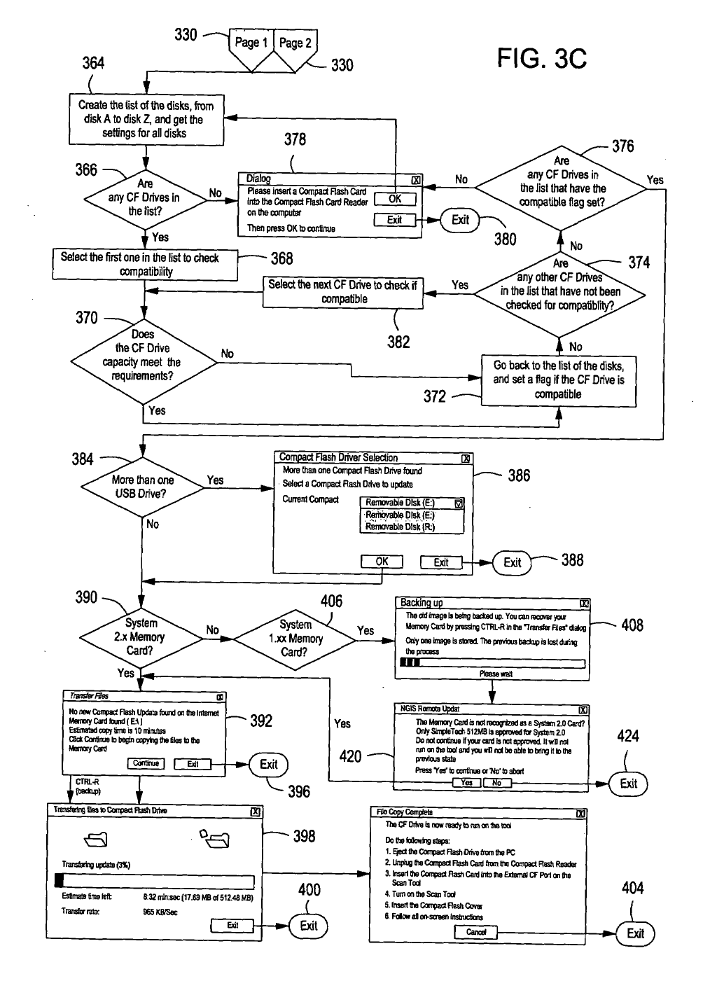

FIG. 3A is a flowchart 300 illustrating steps for updating software on a flash memory. At step 302, the user clicks on an icon or a software launcher on the personal computer or other computing device to launch the NGIS (New Generation Information Software) software stored on the personal computer. The NGIS software name is not meant to be limiting but to help distinguish between the software that does the updating and the scan tool software being updated. At step 304, the NGIS software conducts a self check and initializes the software. If the software is corrupted or shows an error, the software will exit. At step 306, the software looks for a “startid” that may be present. The startid may be present from the last scan tool software that was updated so that the user does not have to reenter which scan tool software he wants to update (if he is doing many updates from the same scan tool brand). The startid can identify which of the various scan tool models will be updated in this session. At step 308, the software reads the startid, if one is present. At step 310, it looks to see if the startid is “1.” In this case, “1” stands for the Nemisys scan tool from SPX Corporation (Owatonna Minn.). If startid “1” is present or yes, then the software proceeds to step 314, where the Nemisys scan tool is identified as the tool that requires the update and then the software proceeds to step 322.

If at step 310, the startid is not “1”, then the software proceeds to step 312, where the software determines if the startid is “2.” If the startid is “2,” then the software proceeds to step 316, where the software identifies that the Solarity scan tool from SPX Corporation is the tool that requires the update. Any number of startids is possible and any scan tool software can be updated with the NGIS. After step 316, the software proceeds to step 322. If at step 312, the startid is not “2,” then the software proceeds to step 318, where the user is presented with a window (graphical user interface) displaying various scan tools that the software can update. In this case, the examples are the Nemisys and Solarity scan tools. It should be noted that any scan tool can be updated via the method described herein and more than two scan tools can be presented in the window in step 318. Step 318 may also be arrived at, when at step 306, the software did not find a startid. At step 320, the user can exit the software by selecting the “Exit” button on the window (step 318) if the desired scan tool was not presented as an option to update or for any other reason.

At step 322, the software presents a window requesting whether the user would like to check the internet for updates. If no, the software proceeds to step 330. If yes, the software proceeds to step 324, where the software determines if there is an internet connection. If no internet connection is present, the software presents a window at step 326, requesting the user to connect the computer to the internet. At this step, the user can also have an option to exit to step 328 for any reason by selecting the “Exit” button on the window (step 326). Once internet connection has been established, the user can select “OK” button on the menu and the software returns to step 322. Again, at step 322, the software determines if there is internet connection. If yes, the software proceeds to step 332.

FIG. 3B is a continuation of flow chart 300 illustrating the steps for updating software on the flash memory. At step 332, the NGIS software proceeds to step 336, where the NGIS software interfaces with a remote computer via the internet to determine if there are any updates available for the NGIS software itself. As stated above, the NGIS software updates the software in the scan tools. If yes or update is available, then the NGIS software proceeds to step 338, where a window alerts the user that there is a new version of the NGIS software and requests whether or not the user wants to download this update. If no update is available, then the software proceeds to step 352. Returning to step 338, if the user selects the “Cancel” button then the NGIS software proceeds to step 352. If at step 338, the user selects “Proceed,” the NGIS software downloads the update to a memory located on the personal computer. At step 340, a window provides the progress of the download. Also at step 340, the user can select the “Exit” button at any time and the NGIS software exits at step 342. The update is completed at step 344, where the software notifies the user via a window that the download was successful and to follow the instructions for completing the remaining steps. At step 346, the updated software proceeds to create an associated startid (the scan tool) with the update software with the appropriate code. At step 348, the user launches the WinZip self extraction software in order to extract the compressed updated software. Once the updated software is extracted, the NGIS software can exit at step 350. Once the NGIS software is updated, the software can reboot and restart automatically or can wait until the user restarts the software at step 302.

At step 352, the NGIS software determines if there is a software update for the scan tool software selected at step 318 or 306. If yes, at step 358, the NGIS software communicates with the remote computer via the internet, presents a window showing download status and downloads the new version. The new version is downloaded as an image file, which contains the entire file system structure so that if the version on the CF card is corrupted, the new version will not be corrupted. The user can also select the “Exit” button at anytime and for any reasons and proceed to step 360 where the software exits or terminates. Once the download is completed, the user can launch the WinZip self-extracting software and extracts the software update to a memory in the personal computer. Then the flowchart proceeds to step 330. If at step 352, there is no update available, then the NGIS software continues to step 356, where a window informs the user that no updates were found. Then the flow chart process to step 330.

FIG. 3C is a continuation of flow chart 300 illustrating the steps for updating software on the flash memory. At step 364, the NGIS software scans the computer for the various drives coupled to the computer and creates a list of their designations (A-Z drives). Then the NGIS software determines the type of drives that are coupled to the computer. The drives can be USB (universal serial bus) drives, floppy disc, CD, DVD, UMD, hard drives, flash memories (CF card), etc. As stated above, scan tool software are often stored on a CF card, which is in a proprietary format not recognizable by the Windows® operating system (O/S) by Microsoft®. Thus, once the CF card (with the scan tool software) is inserted into a card reader coupled to the personal computer, the computer will ask the user if he wants to format the CF card. At this point, the user will cancel the format option offered by the personal computer. The NGIS software is constructed and designed to interact with the operating system (Windows®, Mac X from Apple®, Linux, etc.) of the personal computer to a certain extent. However, the NGIS software does not need to interact with or assisted by the operating system of the personal computer in order to communicate directly with the drivers of the external or internal drives coupled to the personal computer. The NGIS software includes a module that can interact directly with various drivers of the external devices or drives to determine what type (removable or non-removable) are coupled to the computer without interacting with or assisted by the operating system of the computer. In one embodiment, the NGIS software can interact with the drivers for the external memory devices such as the CF card even if the CF card is in a non-proprietary format (such as Windows®, Apple®, Linux® without interacting with or assisted by the operating system of the computer. The NGIS software module may have a communication portion that recognizes various formats used by various scan tool manufacturers and then use that format to read and write to the CF card without interacting with or assisted by the operating system of the computer. The NGIS software includes a module to read and write information on the CF card even though the CF card may be in a proprietary format of the scan tool manufacturer. The module can communicate directly with the various drivers without having to interact with or assisted by the operating system of the computer.

At step 366, from the list, the NGIS software determines if any CF cards are connected to the personal computer regardless of the format. If yes, then the flow chart proceeds to step 368, where the user is requested to select a CF card from the list generated in step 364 to check the CF card's compatibility. If no CF card is present, the NGIS proceeds to step 378, where a window requests the user to insert a CF card into the CF card reader on the computer. Then the user selects the “OK” button and the software rescans the computer and then proceeds to step 366. Additionally, at step 378, the user can select the “Exit” button and the software proceeds to step 380 and exits or terminates.

At step 370, the NGIS software checks the storage capacity of the CF card and determines if it has enough capacity for the software update. If no, the NGIS software proceeds to step 372, where the software returns to a list of CF cards that were detected in step 366 and then proceeds to step 374. If yes, the NGIS proceeds to step 372, where a flag is associated with the CF card that is compatible or has the minimum required capacity. The NGIS software proceeds to step 374, where the user is requested to determine whether there are other CF cards on the list that have not been checked for compatibility. If yes, then the NGIS software request the user to select a CF card that has not been checked for compatibility from the list and proceeds to step 370. If no, then the NGIS software proceeds to step 376, where the software determines if any of the CF cards that were checked are flagged for compatibility. If no, the software returns to step 378 and request the user to insert a CF card into the reader of the computer. If yes, the NGIS software proceeds to step 384. In one embodiment, steps 368, 370, 372, 374, 376 and 382 can be done in the background.

At step 384, the NGIS software determines if there are more than one compatible CF drive connected to the computer. If yes, a list of compatible CF drive is presented in a window at step 386 and the user is requested to select the CF drive (and the CF card) to update with the updated software. Once the CF card is selected, the user can select the “OK” button and the software proceeds to step 390. Additionally, at step 386, the user can select the “Exit” button in the window to exit or terminate the software at step 388. If no, the NSIG software proceeds to step 390 where the NGIS software determines if the CF card contains the latest version of the scan tool software (for example, V.2.X). If yes, then the software proceeds to step 392, where the software determines if there is a new update. If no new update, the window at step 392 will state “No new Compact Flash Update found on the Internet” or a similar message. If there is a new update, the window at step 392 allows the user to download the update onto the CF card by selecting the “Continue” button. The user can back up the CF card by using the CTRL-R function on the computer. By backing up the CF card before updating, the user can save his individual preference settings for the scan tool. At step 392, the user can select the “Exit” button from the window and exit at step 396 to stop the updating process. At step 398, the window can display the time and the amount (Mb) of updates remaining. The window also allows the user to select to “Exit” button to exit at step 400. Once the download is completed, a window is presented at step 402 that further instructs the user after the updated software image has been transferred to the desired CF card. The user can exit by selecting the “Cancel” button. After the updating is completed, the program exit to step 404.

If at step 390, the NGIS software determines that the CF card contains an outdated version of the software, then the software proceeds to step 406 and then step 408, where the software backs up the image of the outdated software including any user preferences. At step 410, the user is requested via a window to make sure he is using an approved CF card. Additionally, the user NGIS software can determine if the software on the CF card is authorized. An approved CF card and/or software will contain information that the NGIS software can read, such as an authorization code in order to determine if the CF card and/or the software on the CF card is authorized. Otherwise, the previous image can not be restored or the new updated version can not be downloaded onto the CF card. At this point, the user can select the “Yes” button to proceed to step 392 or “No” to exit at step 412.

In one embodiment, at steps 390, 406, 408, and 410, the NGIS software can automatically back up the content of the CF card if it detects the card contains something unexpected (for example, different file format (JPEG, TIFF)). This will allow the user to recover the content if by mistakes he inserts a CF card with files formatted for his camera.

The NGIS software can be stored on a computer readable medium such as a compact disc (CD), digital video disc (DVD), CF card or USB drives for installation on the computing device. The NGIS software saves the user countless hours because the software allows the updated software to be written directly onto the CF card instead of first writing to the scan tool from the computer and then the scan tool writing to the CF card. Although the CF card is given as an example, the method described herein can be used with any memory devices including other flash memories. Additionally, instead of the internet, the computer can have the updated image loaded from a CD or DVD or other computer readable medium.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of updating a flash memory device used in a vehicle diagnostic device, comprising:
inserting the flash memory device having a vehicle diagnostic software into a memory card reader of a computing device, the computing device includes an operating system;
communicating with a driver of the memory card reader without interacting with the operating system to determine if the flash memory device is coupled to the computing device;
determining if the flash memory device has enough available memory for an image of an updated vehicle diagnostic software; and
writing the image of the updated vehicle diagnostic software onto the flash memory device without interacting with the operating system of the computing device.

2. The method of claim 1 further comprising:
determining the version of the vehicle diagnostic software on the flash memory device; and
determining if the vehicle diagnostic software installed on the flash memory device is authorized.

3. The method of claim 1 further comprising backing up information stored on the flash memory device before writing the updated vehicle diagnostic software onto the flash memory device.

4. The method of claim 3, wherein the information includes user preference information related to the vehicle diagnostic device.

5. The method of claim 1 further comprising determining if the flash memory device is authorized, wherein writing the image of the updated vehicle diagnostic software on the flash memory device only if the flash memory device is authorized and if there is enough available memory.

6. The method of claim 1, wherein the flash memory device is a compact flash card or a universal serial bus memory drive.

7. The method of claim 1 further comprising determining if the flash memory device and the vehicle diagnostic software stored thereon are authorized, wherein writing the image of the updated vehicle diagnostic software on the flash memory only if the flash memory device and the vehicle diagnostic software thereon are authorized.

8. An article comprising a machine-accessible medium having associated data, wherein the data, when accessed, results in a machine performing:
communicating with a driver of a memory card reader coupled to a computing device without interacting with an operating system of the computing device to determine if a flash memory device is coupled to the memory card reader;
determining if the flash memory device has enough available memory for an image of an updated vehicle diagnostic software; and
writing the image of the updated vehicle diagnostic software on the flash memory device without interacting with the operating system of the computing device.

9. The medium of claim 8 further comprising:
determining a version of a vehicle diagnostic software on the flash memory device; and
determining if the vehicle diagnostic software installed on the flash memory device is authorized.

10. The medium of claim 8 further comprising backing up information stored on the flash memory device before writing the updated vehicle diagnostic software onto the flash memory device.

11. The medium of claim 10, wherein the information includes user preference information related to the vehicle diagnostic device.

12. The medium of claim 8 further comprising determining if the flash memory device is authorized, wherein writing the image of the updated vehicle diagnostic software on the flash memory device only if the flash memory device is authorized and if there is enough available memory.

13. The medium of claim 8 further comprising determining if the flash memory device and the vehicle diagnostic software stored thereon are authorized, wherein writing the image of the updated vehicle diagnostic software on the flash memory only if the flash memory device and the vehicle diagnostic software thereon are authorized.

14. A method of updating a flash memory device used in a vehicle diagnostic device, comprising:
inserting the flash memory device having a vehicle diagnostic software into a memory card reader of a computing device, the computing device includes an operating system;
communicating with a driver of the memory card reader without interacting with the operating system to determine if the flash memory device is coupled to the computing device;
determining if the flash memory device has enough available memory for an image of an updated vehicle diagnostic software;
determining if the flash memory device is authorized; and
writing the image of the updated vehicle diagnostic software onto the flash memory device without interacting with the operating system of the computing device when the flash memory device is authorized and when there is enough available memory.

15. The method of claim 14 further comprising:
determining the version of the vehicle diagnostic software on the flash memory device; and
determining if the vehicle diagnostic software installed on the flash memory device is authorized.

16. The method of claim 14 further comprising determining if the vehicle diagnostic software is authorized, wherein writing the image of the updated vehicle diagnostic software on the flash memory when the vehicle diagnostic software is authorized.

17. The method of claim 14 further comprising backing up information stored on the flash memory device before writing the updated vehicle diagnostic software onto the flash memory device.

18. The method of claim 14, wherein the information includes user preference information related to the vehicle diagnostic device.

19. The method of claim 14, wherein the flash memory device is a compact flash card or a universal serial bus memory drive.

20. The method of claim 14 further comprising reading the information stored on the flash memory device.
